(19) United States
(12) Patent Application Publication
(10) Pub. No.: US 2017/0208071 A1
(43) Pub. Date: Jul. 20, 2017

(54) METHOD AND SYSTEM FOR REAL-TIME TRANSACTION ENABLER POWERED BY INTERACTIVE PATTERN EXCHANGE

(71) Applicant: Siu Hong Chui, Hong Kong (HK)

(72) Inventors: Siu Hong Chui, Hong Kong (HK); Chi Ho Jason Lee, Hong Kong (HK)

(21) Appl. No.: 15/001,152

(22) Filed: Jan. 19, 2016

(51) Int. Cl. H04L 29/06

(52) U.S. Cl. CPC H04L 63/102; H04L 63/123; H04L 63/08

(57) ABSTRACT

A method for interactive pattern exchange includes: triggering a transaction and sending a transaction request to a platform via an access media by a first user device; transmitting a first pattern between the first user device and the platform via the access media; receiving input of a second pattern by the first user device or a second user device; submitting the second pattern to the platform to be verified by the first user device or the second user device; and returning a transaction result with associated data to at least one of the first user device and the second user device according to the result of the verification by the platform.

### FIELD OF THE PATENT APPLICATION

The present patent application generally relates to information technologies and more specifically to a platform/system and a method for interactive pattern exchange related to an electronic transaction which can be used as an add-on to support existing transaction process to generate a secured transaction between users and/or applications.

### BACKGROUND

Nowadays almost every transaction contains data. Each transaction is typically triggered in a form of Person-to-Person (P2P), Application-to-Person (A2P) or Machine-to-Machine (M2M) and may also require some kind of security process to be applied to protect and/or access the data and/or service which involves hardware and the user would need to memorize the instruction key as well as human identity such as finger print.

Generally, whenever a user initiates and respond to a transaction, several steps (i.e. connect, input and submit) are mandatory and the recipient will authenticate the received information to decide whether to put through the transaction forward or reply an associated response to the user. Currently, there are several ways to trigger a transaction which involves P2P, A2P and M2M. An initiator of the transaction is usually required to: connect the target entity, input keys in alphanumeric format, verify the input, and wait for response. Another method requires additional devices or technologies such as dongle, RFID, QR Code or NFC technology.

Credit card payment, RFID access card and dongle use a physical media (i.e. Connect) for transaction triggering. The user keys in (i.e. Input) a password and confirms (i.e. Submit) for authentication before the operation begins.

QR code data requires the user to turn-on a QR code scanner (i.e. Connect) and scan the created QR code (i.e. Input) for transaction triggering, and to use the QR code scanner (at the user device) to decode the data (i.e. Process).

NFC technology requires a user's NFC enabled device to be in pair with a reception terminal (i.e. Connect). The reception terminal will read the user NFC device data (i.e. Input) and the read data will be sent toward an associated application (i.e. Submit) for further processing.

### SUMMARY

The present patent application is directed to a method for interactive pattern exchange. In one aspect, the method includes: triggering a transaction and sending a transaction request to a platform via an access media by a first user device; transmitting a first pattern between the first user device and the platform via the access media; receiving input of a second pattern by the first user device or a second user device; submitting the second pattern to the platform to be verified by the first user device or the second user device; and returning a transaction result with associated data to at least one of the first user device and the second user device according to the result of the verification by the platform.

Input of the second pattern may be received and submitted to the platform by the first user device. Input of the second pattern may be received and submitted to the platform by the second user device. The transaction result with associated data may be returned to both the first user device and the second user device.

The first user device and the second user device may each include a draw panel configured for receiving input of a pattern, while the platform may be a server that runs applications and stores data. The platform may include a transaction engine and a pattern engine configured to handle transactions and generate patterns respectively. The access media may be a mobile network, the Internet or a cloud. The transaction may be triggered through a subscriber identity module attached to the first user device.

The first pattern may be randomly generated by the platform using a set of predefined algorithms and the first pattern may be kept valid for a period of time; or the first pattern may be randomly generated by an initiator of the first user device and the first pattern may be kept valid for a period of time.

The first pattern and the second pattern may each include a pattern frame, a start point, an end point, and a path that includes vectors starting from one position and ending at a next position assigned by the server.

The method may further include sending a level 1 credential and a level 2 credential to the platform by the first user device; and determining a coding rule and generating the first pattern after verifying the level 1 credential and the level 2 credential by the platform. The method may further include preparing a level 3 credential according to the coding rule and sending the second pattern and the level 3 credential to the platform by the first device or the second user device; and verifying the received level 3 credential by the platform. The level 1 credential may include Client Operation Data generated during user's sign-on. The level 2 credential may include Initial User Data generated during user registration and account setup. The level 3 credential may include Draw Panel Data generated by the draw panel of the first user device or the second user device.

In another aspect, the present patent application provides a method for interactive pattern exchange including: triggering a transaction and sending a transaction request to a platform via an access media by a first user device; sending a level 1 credential and a level 2 credential to the platform by the first user device; determining a coding rule and generating the first pattern after verifying the level 1 credential and the level 2 credential by the platform; transmitting a first pattern between the first user device and the platform via the access media; receiving input of a second pattern by the first user device or a second user device; preparing a level 3 credential according to the coding rule and sending the second pattern and the level 3 credential to the platform by the first user device or the second user device; verifying the received level 3 credential by the platform; and returning a transaction result with associated data to at least one of the first user device and the second user device according to the result of the verification by the platform. The first user device and the second user device each include a draw panel configured for receiving input of a pattern, while the platform is a server that runs applications and stores data. The level 1 credential includes Client Operation Data generated during user's sign-on, the level 2 credential includes Initial User Data generated during user registration and account setup, while the level 3 credential includes Draw Panel Data generated by the draw panel of the first user device or the second user device.

Input of the second pattern may be received and submitted to the platform by the first user device. Input of the second pattern may be received and submitted to the platform by the second user device. The transaction result with associated data may be returned to both the first user device and the second user device.

In yet another aspect, the present patent application provides a system for interactive pattern exchange. The system includes: a platform; a first user device connected with the platform through an access media; and a second user device connected with the platform through the access media. The first user device and the second user device each include a draw panel configured for receiving input of a pattern, while the platform is a server that runs applications and stores data. The first user device is configured to trigger a transaction and sending a transaction request to the platform via the access media. The platform is configured to dispatch a first pattern to the first user device via the access media. At least one of the first user device and the second user device is configured to receive input of a second pattern, and submit the second pattern to the platform to be verified. The platform is configured to return a transaction result with associated data to at least one of the first user device and the second user device according to the result of the verification.

The platform may include a transaction engine and a pattern engine configured to handle transactions and generate patterns respectively, while the access media may be a mobile network, the Internet or a cloud.

The first user device may be configured to send a level 1 credential and a level 2 credential to the platform; and the platform may be configured to determine a coding rule and generate the first pattern after verifying the level 1 credential and the level 2 credential. At least one of the first user device and the second user device may be configured to prepare a level 3 credential according to the coding rule and send the second pattern and the level 3 credential to the platform; and the platform may be configured to verify the received level 3 credential.

The level 1 credential may include Client Operation Data generated during user's sign-on. The level 2 credential may include Initial User Data generated during user registration and account setup, while the level 3 credential may include Draw Panel Data generated by the draw panel of the first user device or the second user device.

### BRIEF DESCRIPTIONS OF THE DRAWINGS

FIG. 1 illustrates a system for interactive pattern exchange in accordance with an embodiment of the present patent application.

FIG. 2A illustrates a method for interactive pattern exchange in accordance with an embodiment of the present patent application.

FIG. 2B shows an access layer for data transport and an application layer for logical connections for a system for interactive pattern exchange in accordance with an embodiment of the present patent application.

FIG. 2C illustrates logic flows of a system for interactive pattern exchange interacting with users, user devices and applications.

FIG. 3 is a flow chart illustrating a method for interactive pattern exchange in accordance with an embodiment of the present patent application.

FIG. 4 is a flow chart illustrating a method for interactive pattern exchange in accordance with another embodiment of the present patent application.

FIG. 5A illustrates some elements of a pattern.

FIG. 5B illustrates some other elements of a pattern.

FIG. 5C illustrates process flows for pattern generation and data validation.

FIG. 5D illustrates an example of pattern generation with 4 vectors.

FIG. 6 is a flow chart illustrating a method for interactive pattern exchange in accordance with another embodiment of the present patent application.

FIG. 7A illustrates a user A initiates a transaction to a user B with a system for interactive pattern exchange in accordance with an embodiment of the present patent application.

FIG. 7B illustrates more detailed steps in the process depicted in FIG. 7A.

FIG. 8A illustrates a user A initiates a transaction to an applications with a system for interactive pattern exchange in accordance with another embodiment of the present patent application.

FIG. 8B illustrates more detailed steps in the process depicted in FIG. 8A.

### DETAILED DESCRIPTION

Reference will now be made in detail to a preferred embodiment of the system and the method for interactive pattern exchange disclosed in the present patent application, examples of which are also provided in the following description. Exemplary embodiments of the system and the method for interactive pattern exchange disclosed in the present patent application are described in detail, although it will be apparent to those skilled in the relevant art that some features that are not particularly important to an understanding of the system and the method for interactive pattern exchange may not be shown for the sake of clarity.

Furthermore, it should be understood that the system and the method for interactive pattern exchange disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

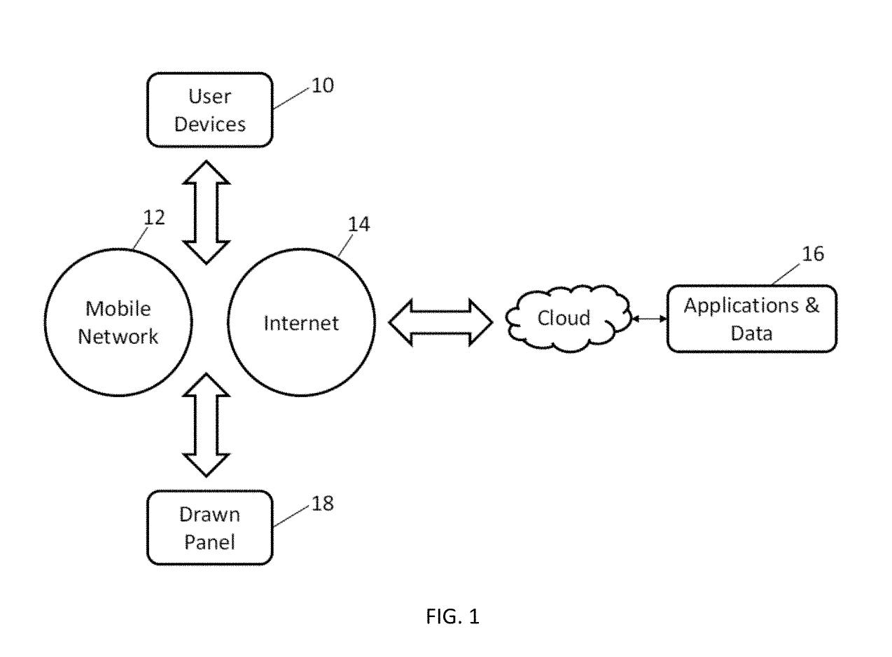

FIG. 1 illustrates a system for interactive pattern exchange in accordance with an embodiment of the present patent application. Referring to FIG. 1, the system includes at least one user device 10 that runs a client application for a user to initiate a transaction and create a pattern if required, an input device that includes a draw panel 18 (the input device is not limited to desktop, smartphone or tablet) for the user to input a pattern, and an application server 16 that runs applications and stores data. The application server 16 includes a Transaction Engine and a Pattern Engine configured to handle transactions and generate patterns respectively.

The user device 10 may be a smart phone, tablet or other equipment (the trigger device is not limited to desktop, smartphone or tablet) configured to trigger a transaction and send or receive an assigned pattern to or from the application server 16. In other words, the assigned pattern is transmitted between the user device 10 and the application server 16. The mobile network 12, the Internet 14, or a Cloud is the access media for data transport. Applications & Data on the application server 16 are the programming logics for generating pattern and its associated resources. The draw panel 18 is the pattern input area on the user device(s) 10 and/or user device(s) (18).

Referring to FIG. 1, an initiator's user device 10 is configured with application software provided by the embodiment. The initiator is enabled for any interactive pattern exchange for transaction triggering, for example contact information of predefined data using the application. However, it is understood that triggering of transaction is not limited to the use of the application in the user device 10 of the initiator. The initiator can optionally make use of conventionally available software tools and/or hardware for triggering the transaction as well as a subscriber identity module (SIM) attached to the user device.

Although the application software is pre-configured in the user device 10, it is understood that the application can also be accessible by the initiator through a web service using a user device 10 over a communication network, preferably the Internet. It is also understood that the implementation of the present application platform is not limited to the use of a specific operating platform, Windows, Linux, UNIX, or the like, or any programming language.

Referring to FIG. 1, the user device 10 of the initiator makes use of a subscribed mobile communication network 12 or Internet facilities 14 to communicate or trigger any other user devices or applications.

FIG. 1 also shows an exemplary configuration in which cloud-based storage and retrieval is implemented in accordance with the embodiment. As depicted in FIG. 1, the user device 10 of the initiator is enabled with the application being used by which the initiator can trigger a transaction by him/her into the applications and data 16. One cloud-based service, Applications and Data of a third-party entity is shown in FIG. 1 for simplicity. It is understood that there may be a number of cloud-based services, such as iCloud, Dropbox, and so on.

An embodiment of the present patent application is to trigger a transaction and complete it with two to three manual intervention steps by pattern request, while input pattern and confirmation are optional.

User activities are treated as a transaction while P2P, A2P and M2M activities, which may further extend to other e-commerce platform integrations, are supported. The functions and features that require an authentication, verification and/or confirmation may make use of interactive pattern exchange as a checkpoint and the functions and features may continue to proceed with their require action(s) if necessary.

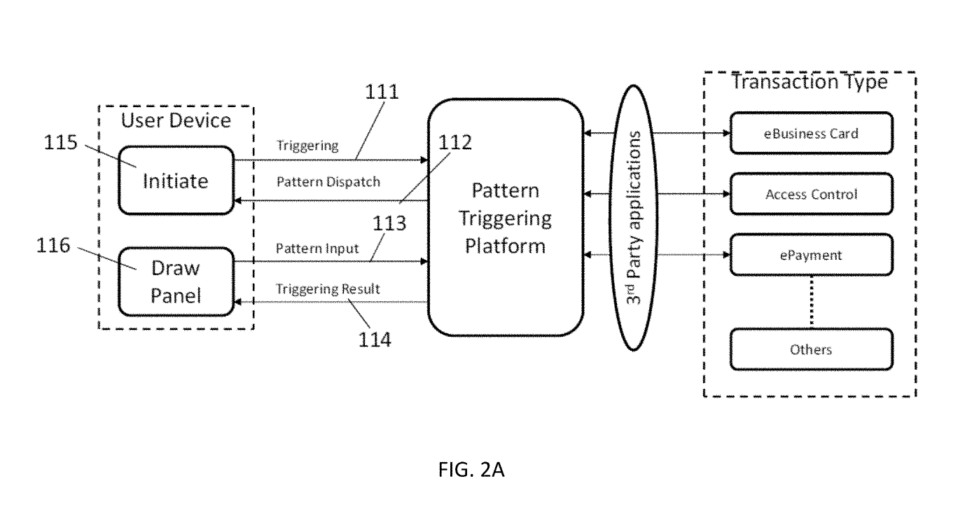

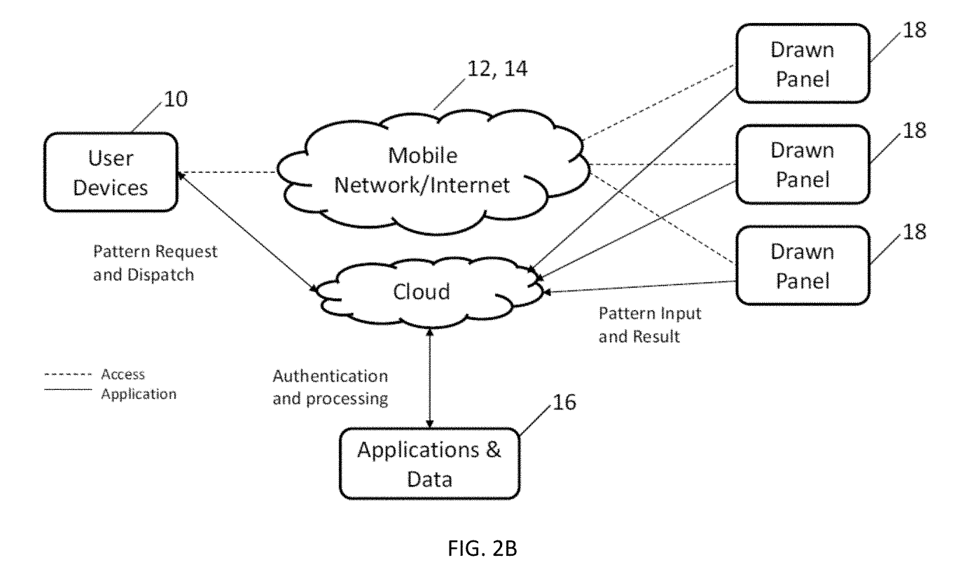

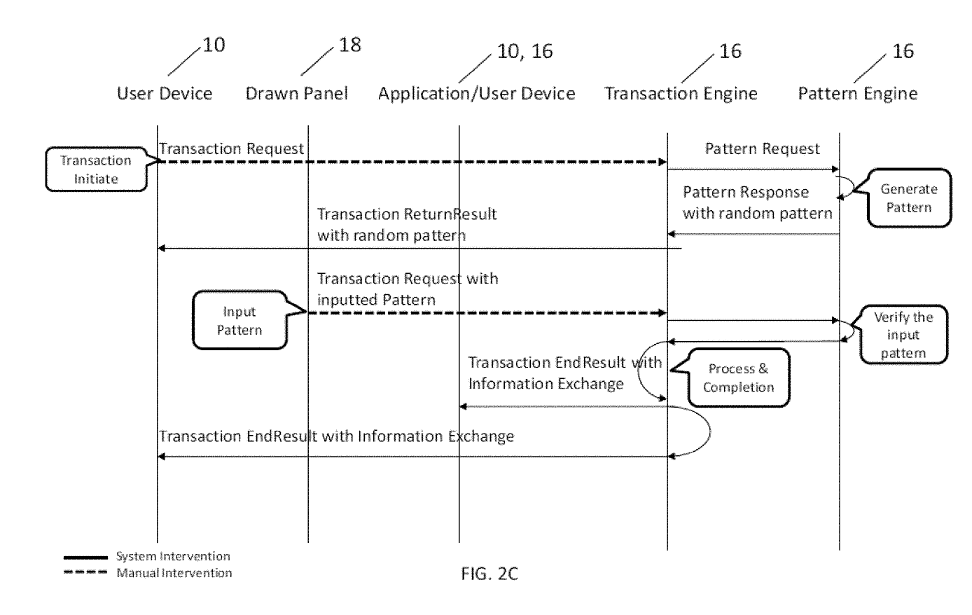

The user will initiate a transaction and trigger/complete the transaction by entering a pattern on the mobile phone/device to be validated by the platform before putting through to the next step as shown in FIGS. 2A-2C. The pattern is randomly generated by the application platform using a set of predefined algorithms and it should be valid for a period of time.

Further to the transaction procedures triggered by interactive pattern exchange as shown in FIGS. 2A-2C, an initial verification is provided for the application on the transaction request which can be applied to the any type of transactions.

FIG. 2A illustrates a method for interactive pattern exchange in accordance with an embodiment of the present patent application. Referring to FIG. 1 and FIG. 2A, the method includes steps that are described in the following table.

| Steps | Origination | Destination | Action |
|---|---|---|---|
| 111 | 10 | 16 | Trigger a transaction by User Device |
| | | | A and the Transaction Request is sent |
| | | | to the platform via access media |
| 112 | 16 | 10 | Transmit Pattern Dispatch to User |
| | | | Device A via the access media |
| 113 | 18 | 16 | Pattern Input and Submission to the |
| | | | platform for verification and return the |
| | | | result |
| 114 | 16 | 10 | Return the transaction result with the |
| | | | associated data which depends on the |
| | | | type of transaction |

It is noted that the user device 115 that triggers the transaction and receives the pattern dispatch may be different from the user device 117 that includes the draw panel for inputting the pattern and triggering the result. It is further noted that there may be more than one user device 117 configured for inputting the pattern and triggering the result.

FIG. 2B shows an access layer for data transport and an application layer for logical connections for a system for interactive pattern exchange in accordance with an embodiment of the present patent application. FIG. 2C illustrates logic flows of the system for interactive pattern exchange interacting with users, user devices and applications. Referring to FIGS. 2A-2C, a user initiates an activity on the user device 10 and a pattern request will be triggered to the application server 16. The application running on the application server 16 will generate a pattern for the user and such pattern will be valid for a period (i.e. counted by a timer). The pattern will be delivered through the access media (12, 14) and displayed with a start position, an end position and a track on the user device 10.

The draw panel 18 is configured for the user to input the provided pattern. When its reaches the end position, the inputted pattern submitted by the Draw Panel is transmitted through the transport media (12, 14) toward the application server 16 to be further processed.

In the pattern request and the draw panel, the following information is included: Initial User Data, Client Operation Data, Draw Panel Data, SIM is optional, for security purposes and improving the validation accuracy, which will be described hereafter in more detail.

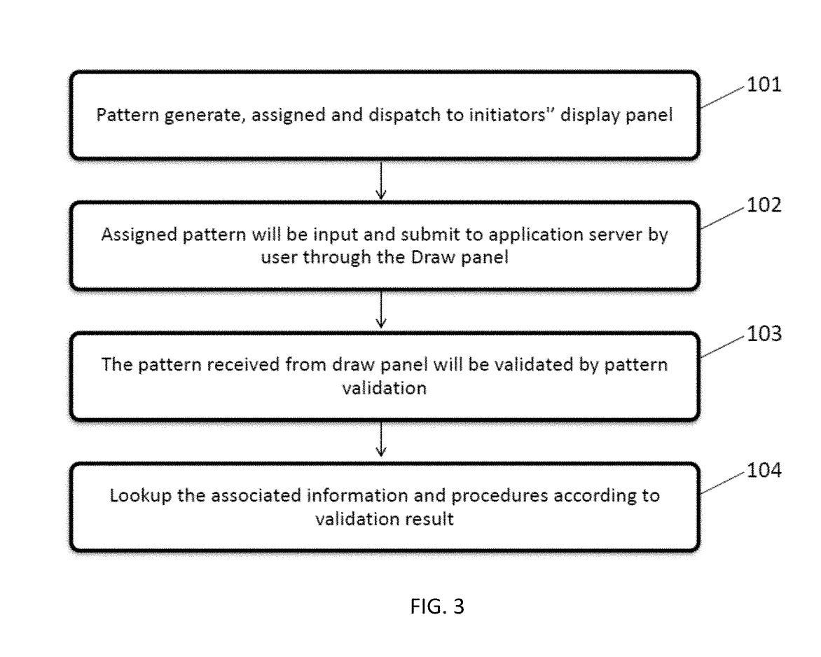

FIG. 3 is a flow chart illustrating a method for interactive pattern exchange in accordance with an embodiment of the present patent application. Referring to FIG. 3, the method includes the following steps:

Step 101: the user initiates (i.e. Connect) a transaction and get a pattern from an application server 16;

Step 102: the user will submit (i.e. Input & submit) a pattern from the draw panel 18 to the application server 16;

Step 103: a security check is run to verify the inputted pattern in the application server 16; and

Step 104: transaction result is returned to the reception terminal (10 and/or 18).

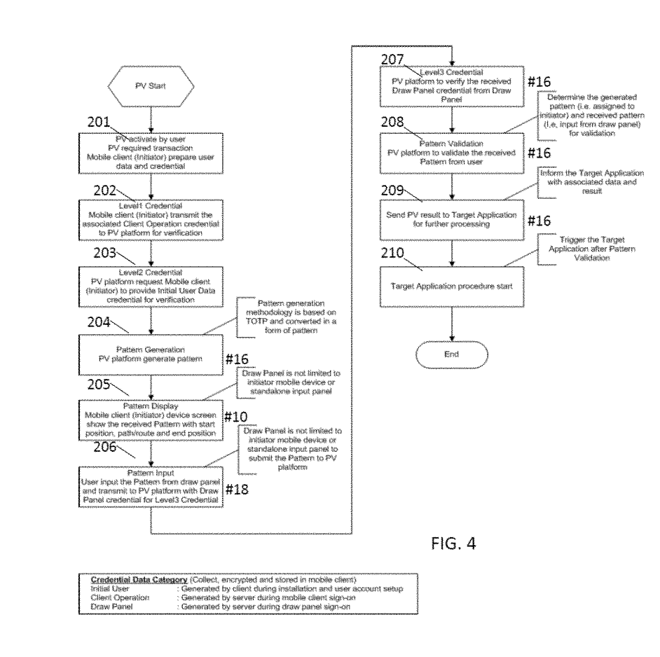

FIG. 4 is a flow chart illustrating a method for interactive pattern exchange in accordance with another embodiment of the present patent application. Referring to FIG. 4, the method includes:

Step 201: a mobile client 10 opens and prepares an authentication rule to be used for authentication;

Step 202: the mobile client 10 sends a level 1 credential to a server 16 for authentication;

Step 203: the mobile client 10 sends a level 2 credential to the server 16 for authentication;

Step 204: the server 16 generates a pattern for request;

Step 205: the server 16 deliver the pattern to the mobile client 10;

Step 206: a draw panel 18 sends the inputted pattern with a level 3 credential to the server 16;

Step 207: the server 16 authenticates the received credential from the draw panel 18;

Step 208: the server 16 verifies the received inputted pattern from the draw panel 18;

Step 209: the server 16 sends the verification result in step 208 to a target application; and

Step 210: the target application starts to determine a next step based the result of the step 209.

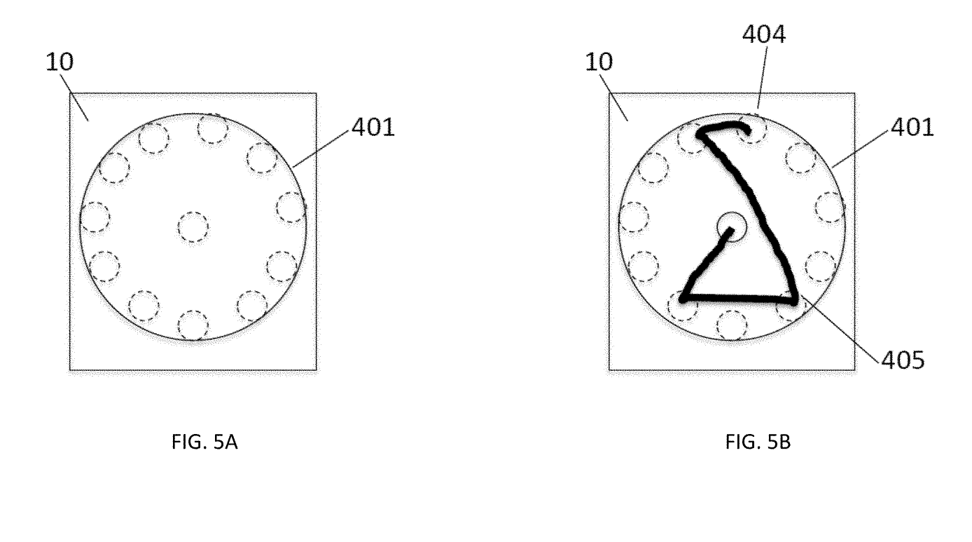

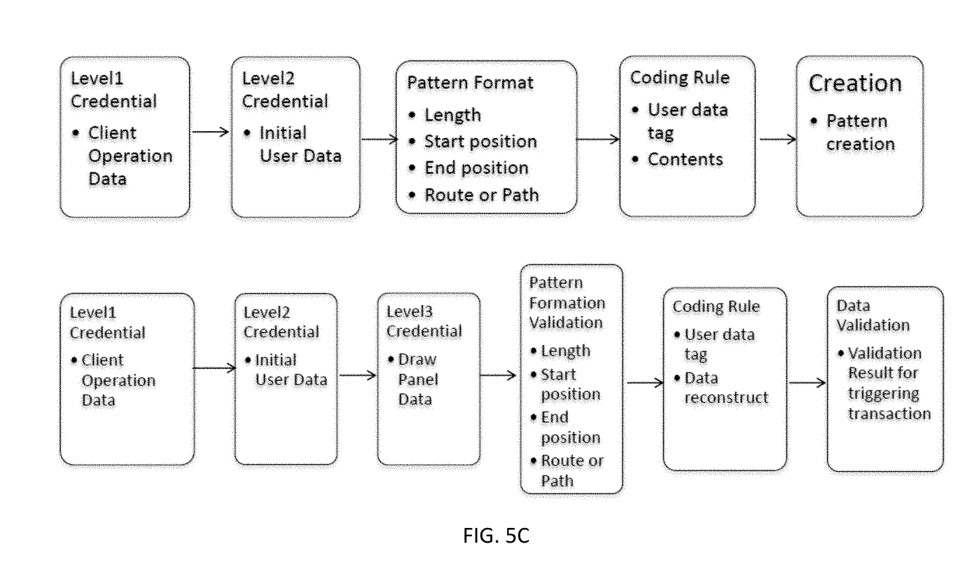

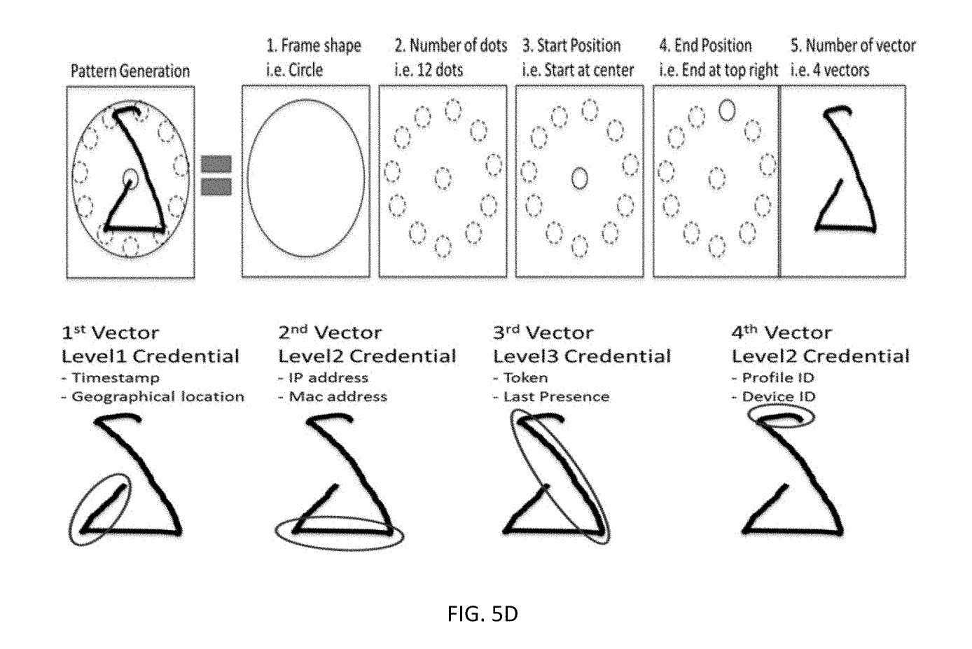

FIGS. 5A and 5B illustrate various elements related to the pattern generation process. Referring to FIG. 5A, in the user device 10, a pattern frame 401 is the shape and border containing the pattern format. The pattern format includes the number of position/dots inside the pattern frame, the number of vectors and validation rules. Referring to FIG. 5B, a start position 403 is the start position/dots of a pattern. An end position 404 is the end position/dots of a pattern. A Path/Route 405 includes vectors starting from one position and ending at the next position assigned by the server. It is noted that the design and look-and-feel of the various elements vary and should be randomly distributed by the pattern engine.

FIG. 5C illustrates process flows for pattern generation and data validation. The pattern generated upon request is received at the mobile client, each pattern being dedicated to an individual transaction and it will be invalid after the timer expires.

FIG. 5D illustrates an example of pattern generation with 4 vectors. Referring to FIG. 5D, each pattern generation should be in the following structure:

1. Frame shape

2. Number of dots

3. Number of vector

4. Start position

5. End position

6. Coding rule

The coding rules are predefined in a backend server for authentication purpose and/or transaction matching if required information exchanges between the parties. Coding rule is dynamically assigned to each pattern request and multiple formed vectors which are in combination with credential levels and the vectors may be in single order or sequential order.

Each vector has 2 dots and each dot is associated with one credential data which is generated during users' activities with the mobile applications. The credentials in the vector should be sent towards the backend server for authentication after the recipient submits the pattern from the draw panel.

From the pattern example with 4 vectors assigned coding rule should send the correspondence data towards the server after the end user inputs the pattern from the draw panel.

Referring to FIG. 5C, the coding rule defines the data to be used for authentication and determination of the transaction result. An authentication vector is associated with Initial User Data (Level 2 Credential), Client Operation Data (Level 1 Credential) and/or Draw Panel Data (Level 3 Credential), which are transmitted to the server 16. Initial User Data is generated during a user registration and account setup. Client Operation Data is generated during the mobile client's sign-on. Draw Panel Data is generated during draw panel's operation. The following table describes more details of the content of these different types of data.

| | Initial User | Client Operation | Draw Panel |
|---|---|---|---|
| | Data | Data | Data |
| | (Level 2 | (Level 1 | (Level 3 |
| Data example | Credential) | Credential) | Credential) |
| Mobile number | Y | | |
| Account ID | Y | | |
| Profile ID | Y | | |
| Device ID | Y | | |
| OS version | Y | | |
| Installed app | Y | | |
| Timestamp | Y | Y | Y |
| Geographical | Y | Y | Y |
| location | | | |
| Access media | Y | Y | Y |
| Mobile network | Y | Y | Y |
| MAC address | Y | Y | Y |
| IP address | Y | Y | Y |
| Token | | Y | Y |
| Last presence | | Y | Y |
| Counter | | Y | Y |

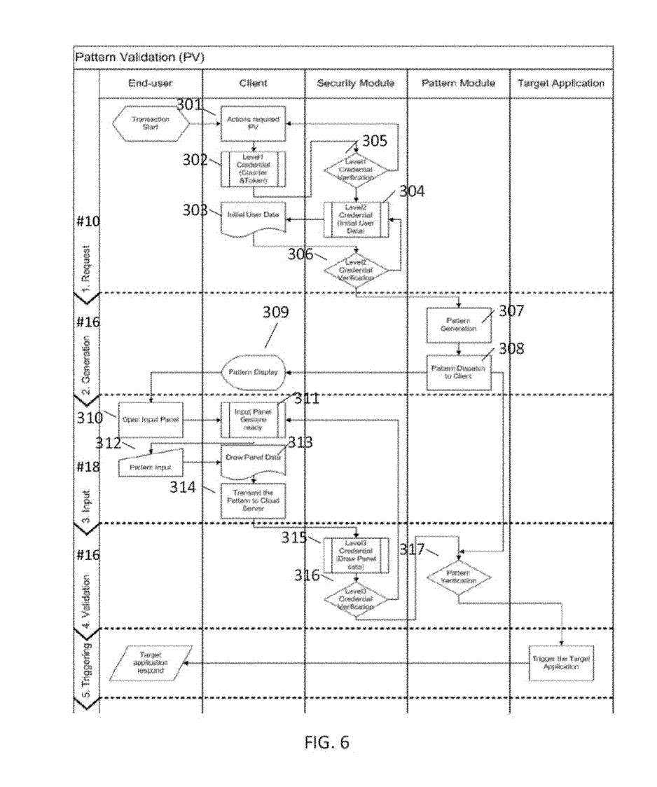

FIG. 6 is a flow chart illustrating a method for interactive pattern exchange in accordance with another embodiment of the present patent application. Referring to FIG. 6, the method includes:

Step 301: an end user opens a mobile client 10 and connects to the Internet by available access media;

Step 302: the mobile client 10 sends level 1 credential to the server 16 for authentication;

Step 303: the mobile client 10 sends level 2 credential to the server 16 for authentication;

Step 304: the server 16 sends request to the mobile client 10 for level 2 credential data;

Step 305: the server 16 verifies the level 1 credential data from the step 302;

Step 306: the server 16 verifies the level 2 credential data from the step 303;

Step 307: the server 16 determines the coding rule and generates a pattern for such request;

Step 308: the server 16 sends the pattern via available access media;

Step 309: the mobile client 10 displays the pattern on its screen;

Step 310: the end user opens the draw panel 18 and connects to the Internet by available access media;

Step 311: the draw panel 18 is ready and displays the pattern frame;

Step 312: the end user inputs the pattern from the draw panel 18;

Step 313: the draw panel 18 prepares level 3 credential data according to the coding rule;

Step 314: the draw panel 18 sends the inputted pattern with level 3 credential to the server 16;

Step 315: the server 16 determines the coding rule for level 3 credential data from the step 314;

Step 316: the server 16 verifies the level 3 credential data from the step 314; and

Step 317: the server 16 sends the verification result from the step 316 to a target application.

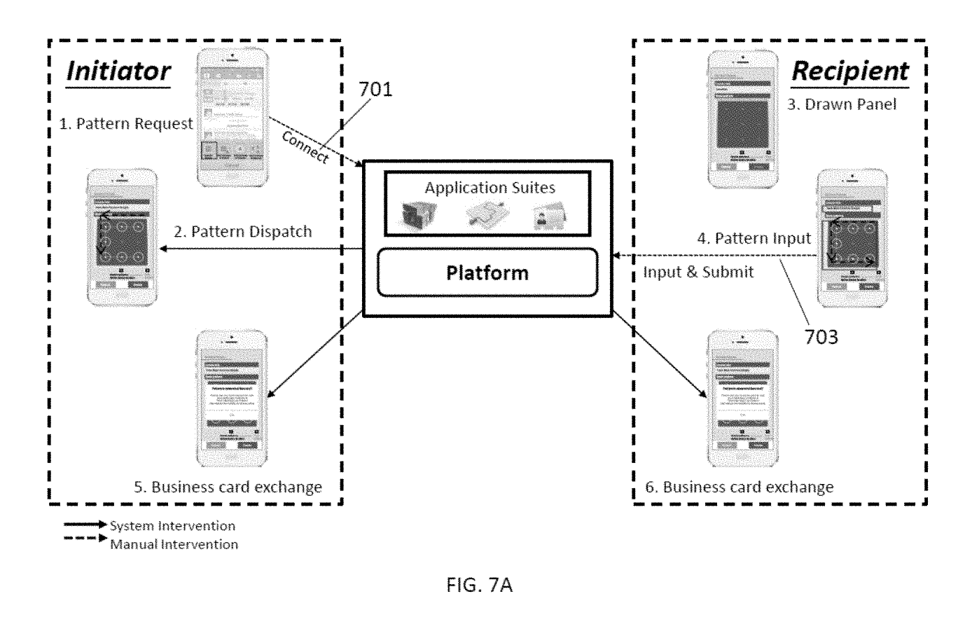

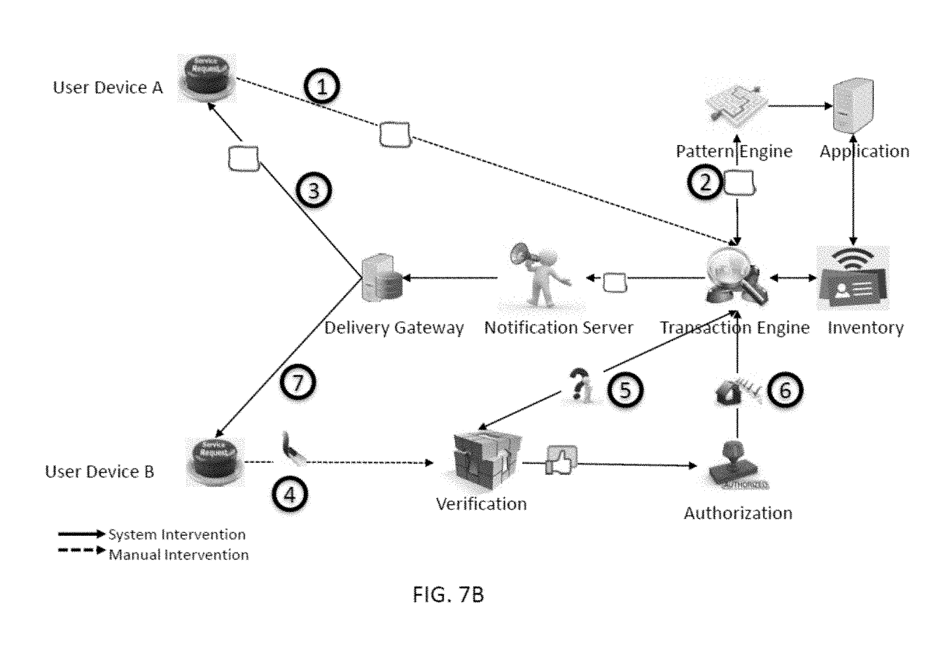

FIG. 7A illustrates a user A initiates a transaction to a user B with a system for interactive pattern exchange in accordance with an embodiment of the present patent application. Referring to FIG. 7A, the user A clicks or selects an activity in the application (i.e. Transaction Request), and then a draw panel is shown on the user device automatically with a pattern with a start position with a track toward an end position. The user A can show this pattern to the user B. The user B clicks or selects the draw panel, and input the pattern by following the displayed track on the user A's device and as soon as the input is completed, the pattern is submitted to the server automatically. The user A will receive a confirmation request for such activity depending on the transaction requirement (optional). Only two manual interventions (as shown in dashed arrows in FIG. 7A) are required.

FIG. 7B illustrates more detailed steps in the process depicted in FIG. 7A. The detailed steps are described in the following table.

| Steps | Origination | Destination | Action |
|---|---|---|---|
| 1 | User Device A (10) | Transaction Engine | Trigger a transaction by |
| | | (16) | User Device A and the |
| | | | Transaction Request |
| | | | sent to the platform |
| 2 | Transaction Engine | Pattern Engine (16) | Pattern Generation and |
| | (16) | | notify the associated |
| | | | application for further |
| | | | handling later on |
| 3 | Pattern Engine (16) | User Device A (10) | Transmit Pattern |
| | | | Dispatch to User |
| | | | Device A via the |
| | | | transport media |
| 4 | User Device B (10) | Verification (16) | Input Pattern from the |
| | | | Draw Panel |
| 5 | Verification (16) | Transaction Engine | Pattern verification and |
| | | (16) | return the result |
| 6 | Verification (16) | Authorization (16) | Put through the |
| | | | transaction |
| 7 | Transaction Engine | User Device A (10) | Return the transaction |
| | (16) | User Device B (10) | result with the |
| | | | associated data which |
| | | | depends on the type of |
| | | | transaction |

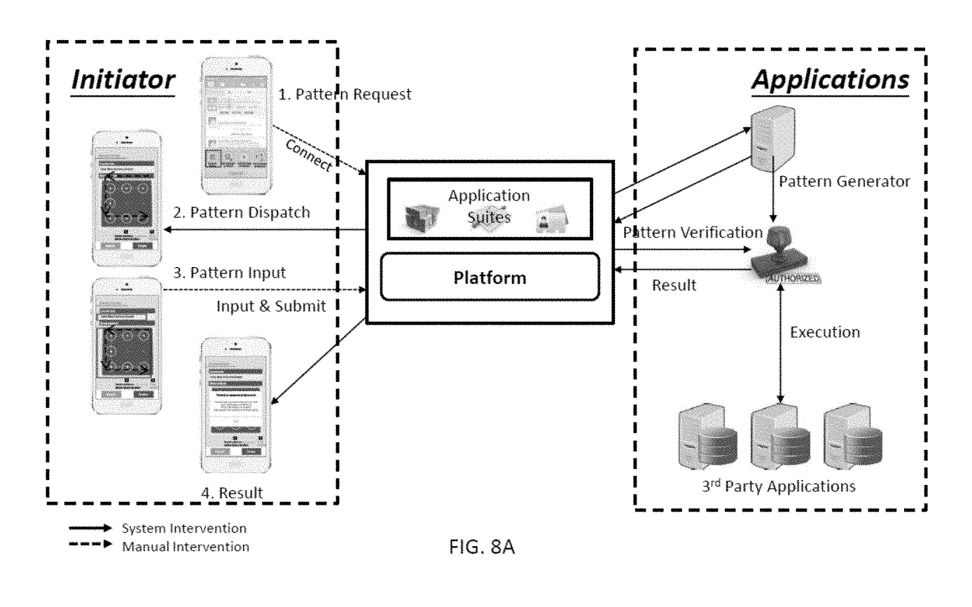

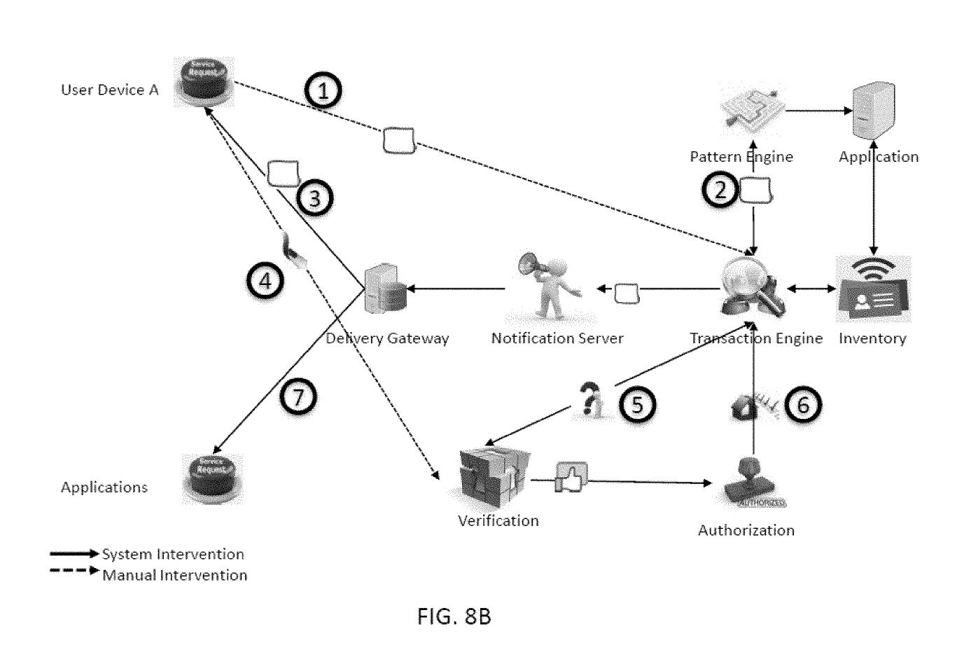

FIG. 8A illustrates a user A initiates a transaction to an applications with a system for interactive pattern exchange in accordance with another embodiment of the present patent application. Referring to FIG. 8A, a user clicks or selects the function in the application (i.e. Transaction Request) and then a draw panel is shown on the user device automatically with a pattern with start position with a track toward an end position. The user A inputs the pattern by following the displayed track on the device and as soon as the input is completed, it is submitted to the server automatically. The user A then receives a confirmation request for such activity depending on the transaction requirement (Optional). Only two manual interventions are required as shown in dashed lines in FIG. 8A.

FIG. 8B illustrates more detailed steps in the process depicted in FIG. 8A. The detailed steps are described in the following table.

| Steps | Origination | Destination | Action |
|---|---|---|---|
| 1 | User Device A (10) | Transaction Engine | Trigger a transaction by |
| | | (16) | User Device A and the |
| | | | Transaction Request is |
| | | | sent to the platform |
| 2 | Transaction Engine | Pattern Engine (16) | Patten Generation and |
| | (16) | | notify the associated |
| | | | application for further |
| | | | handling later on |
| 3 | Pattern Engine (16) | User Device A (10) | Pattern Dispatch |
| | | | transmitted to User |
| | | | Device A via the |
| | | | transport media |
| 4 | User Device A (10) | Verification (16) | Input Pattern from the |
| | | | Draw Panel |
| 5 | Verification (16) | Transaction Engine | Pattern verification and |
| | | (16) | return the result |
| 6 | Verification (16) | Authorization (16) | Put through the |
| | | | transaction |
| 7 | Transaction Engine | User Device A (10) | Return the transaction |
| | (16) | Applications (16) | result with the |
| | | | associated data which |
| | | | depends on the type of |
| | | | transaction |

The above-mentioned embodiments provide an improved, easy and cost effective way for the user to trigger transaction procedures with other entities, allowing an initiator to control and protect the required transaction with authentication vectors and authorization rules by manual intervention before the request is put through to the next execution point. The embodiments enable any kind of transaction procedure triggered with validation in a form of fixed variable authorization method transformed to a dynamic variable authorization method. Such method addresses the type of transactions process that requires interactions between the parties, verification and control. The embodiments provide a new and unique way of protection and/or service enabler facilitating any type of electronic transaction in a real-time manner, which supports user(s) or server(s) pattern generation in accordance to the application and transaction requirements.

In still another embodiment, finger print recognition can be incorporated by generating unique patterns based on finger prints impressed against the monitor as receiving device. The benefit of this is creating more secured method other than SIM, and potentially selling much more easily to banks and etc. who have to be 100% secure.

In still another embodiment, it does not matter in which direction or order the vectors are drawn by joining the dots, or if joining the dots is required at all. The initiator can only touch the dots without joining them by drawing vectors.

While the present patent application has been shown and described with particular references to a number of embodiments thereof, it should be noted that various other changes or modifications may be made without departing from the scope of the present invention.

What is claimed is:

1. A method for interactive pattern exchange comprising:
triggering a transaction and sending a transaction request to a platform via an access media by a first user device;
transmitting a first pattern between the first user device and the platform via the access media;
receiving input of a second pattern by the first user device or a second user device;
submitting the second pattern to the platform to be verified by the first user device or the second user device; and
returning a transaction result with associated data to at least one of the first user device and the second user device according to the result of the verification by the platform.

2. The method of claim 1, wherein input of the second pattern is received and submitted to the platform by the first user device.

3. The method of claim 1, wherein input of the second pattern is received and submitted to the platform by the second user device.

4. The method of claim 3, wherein the transaction result with associated data is returned to both the first user device and the second user device.

5. The method of claim 1, wherein the first user device and the second user device each comprise a draw panel configured for receiving input of a pattern, while the platform is a server that runs applications and stores data.

6. The method of claim 5, wherein the platform comprises a transaction engine and a pattern engine configured to handle transactions and generate patterns respectively, the access media is a mobile network, the Internet or a cloud, while the transaction is triggered through a subscriber identity module attached to the first user device.

7. The method of claim 1, wherein the first pattern is randomly generated by the platform using a set of predefined algorithms and the first pattern is kept valid for a period of time; or the first pattern is randomly generated by an initiator of the first user device and the first pattern is kept valid for a period of time.

8. The method of claim 1, wherein the first pattern and the second pattern each comprise a pattern frame, a start point, an end point, and a path that comprises vectors starting from one position and ending at a next position assigned by the server.

9. The method of claim 5 further comprising sending a level 1 credential and a level 2 credential to the platform by the first user device; and determining a coding rule and generating the first pattern after verifying the level 1 credential and the level 2 credential by the platform.

10. The method of claim 9 further comprising preparing a level 3 credential according to the coding rule and sending the second pattern and the level 3 credential to the platform by the first device or the second user device; and verifying the received level 3 credential by the platform.

11. The method of claim 9, wherein the level 1 credential comprises Client Operation Data generated during user's sign-on, the level 2 credential comprises Initial User Data generated during user registration and account setup, while the level 3 credential comprises Draw Panel Data generated by the draw panel of the first user device or the second user device.

12. A method for interactive pattern exchange comprising:
triggering a transaction and sending a transaction request to a platform via an access media by a first user device;
sending a level 1 credential and a level 2 credential to the platform by the first user device;
determining a coding rule and generating the first pattern after verifying the level 1 credential and the level 2 credential by the platform;
transmitting a first pattern between the first user device and the platform via the access media;
receiving input of a second pattern by the first user device or a second user device;
preparing a level 3 credential according to the coding rule and sending the second pattern and the level 3 credential to the platform by the first user device or the second user device;
verifying the received level 3 credential by the platform; and
returning a transaction result with associated data to at least one of the first user device and the second user device according to the result of the verification by the platform; wherein:
the first user device and the second user device each comprise a draw panel configured for receiving input of a pattern, while the platform is a server that runs applications and stores data; and
the level 1 credential comprises Client Operation Data generated during user's sign-on, the level 2 credential comprises Initial User Data generated during user registration and account setup, while the level 3 credential comprises Draw Panel Data generated by the draw panel of the first user device or the second user device.

13. The method of claim 12, wherein input of the second pattern is received and submitted to the platform by the first user device.

14. The method of claim 12, wherein input of the second pattern is received and submitted to the platform by the second user device.

15. The method of claim 14, wherein the transaction result with associated data is returned to both the first user device and the second user device.

16. A system for interactive pattern exchange comprising:
a platform;
a first user device connected with the platform through an access media; and
a second user device connected with the platform through the access media; wherein:
the first user device and the second user device each comprise a draw panel configured for receiving input of a pattern, while the platform is a server that runs applications and stores data;
the first user device is configured to trigger a transaction and sending a transaction request to the platform via the access media;
the platform is configured to dispatch a first pattern to the first user device via the access media;
at least one of the first user device and the second user device is configured to receive input of a second pattern, and submit the second pattern to the platform to be verified; and
the platform is configured to return a transaction result with associated data to at least one of the first user device and the second user device according to the result of the verification.

17. The system of claim 16, wherein the platform comprises a transaction engine and a pattern engine configured to handle transactions and generate patterns respectively, while the access media is a mobile network, the Internet or a cloud.

18. The system of claim 16, wherein the first user device is configured to send a level 1 credential and a level 2 credential to the platform; and the platform is configured to determine a coding rule and generate the first pattern after verifying the level 1 credential and the level 2 credential.

19. The system of claim 18, wherein at least one of the first user device and the second user device is configured to prepare a level 3 credential according to the coding rule and send the second pattern and the level 3 credential to the platform; and the platform is configured to verify the received level 3 credential.

20. The system of claim 18, wherein the level 1 credential comprises Client Operation Data generated during user's sign-on, the level 2 credential comprises Initial User Data generated during user registration and account setup, while the level 3 credential comprises Draw Panel Data generated by the draw panel of the first user device or the second user device.
